(19) United States
(12) Patent Application Publication
(10) Pub. No.: US 2013/0055118 A1
(43) Pub. Date: Feb. 28, 2013

(54) CONFIGURING DATABASE OBJECTS IN MULTI-TENANT SYSTEMS

(71) Applicants: Daniel Jacob Donovan, San Francisco, CA (US); Evan Michael Moses, San Francisco, CA (US); Mary Kathryn Scotton, Gladstone, NJ (US)

(72) Inventors: Daniel Jacob Donovan, San Francisco, CA (US); Evan Michael Moses, San Francisco, CA (US); Mary Kathryn Scotton, Gladstone, NJ (US)

(73) Assignee: SALESFORCE.COM, INC., San Francisco, CA (US)

(21) Appl. No.: 13/439,659

(22) Filed: Apr. 4, 2012

Related U.S. Application Data
(60) Provisional application No. 61/528,458, filed on Aug. 29, 2011.

(51) Int. Cl. G06F 3/048

(52) U.S. Cl. 715/763

(57) ABSTRACT

Methods and systems are provided for configuring objects in a multi-tenant system. One exemplary method for configuring objects involves providing a graphical user interface including a display region corresponding to the object, identifying an object type for the object, determining a possible configuration action for the object based at least in part on the object type, and providing a graphical user interface element corresponding to the possible configuration action within the graphical user interface. In one embodiment, the graphical user interface is a tabbed interface display corresponding to an instance of virtual customer relationship management application provided by an application server in a multi-tenant system and the object is maintained in a multi-tenant database, wherein the tabbed interface display includes a tab for the object and the display region corresponds to the object when the tab is activated.

### CROSS-REFERENCE TO RELATED APPLICATION(S)

This application claims the benefit of U.S. provisional patent application Ser. No. 61/528,458, filed Aug. 29, 2011, the entire content of which is incorporated by reference herein.

### TECHNICAL FIELD

Embodiments of the subject matter described herein relate generally to computer systems and networks configured to support applications executing on behalf of multiple tenants, and more particularly, embodiments of the subject matter relate to methods and systems for configuring objects and applications in a multi-tenant system.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

In practice, the different tenants often have different types of data and/or different relationships between data that they would like to maintain in the multi-tenant system, along with different types of operations they would like to be able to perform on their data. Accordingly, some multi-tenant systems include an application platform that may be utilized by users to create user-specific and/or tenant-specific objects in the multi-tenant database and accompanying user-specific and/or tenant-specific applications integrating those custom objects and supporting various features with respect to those custom objects (e.g., reports, tables, functions, etc.). From time to time, users may desire to modify the custom objects and/or custom applications, however, making the desired modifications can be difficult and time-consuming for users who are relatively inexperienced with computer programming or are otherwise unfamiliar with the multi-tenant system.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary multi-tenant system;

FIG. 2 is a flow diagram of an exemplary customization process suitable for use with the multi-tenant system of FIG. 1 in accordance with one or more exemplary embodiments; and

FIGS. 3-8 illustrate exemplary graphical user interface displays that may be presented on a client computing device in the multi-tenant system of FIG. 1 in connection with the customization process of FIG. 2 in accordance with one or more exemplary embodiments.

### DETAILED DESCRIPTION

Embodiments of the subject matter described herein generally relate to configuring objects and/or applications in a multi-tenant system. As described in greater detail below, in an exemplary embodiment, an application server generates an instance of a virtual application that utilizes objects and metadata maintained in a multi-tenant database and presents or otherwise provides a graphical user interface (GUI) corresponding to that virtual application on a client device coupled to the application server over a network. The GUI includes a display region corresponding to an object or another configurable element in the multi-tenant database and a configuration menu GUI element. When the configuration menu GUI element is activated or otherwise selected, possible configuration actions are determined based on the object type for the displayed object and a view setting for the display region and the configuration menu is populated with GUI elements corresponding to the possible configuration actions. In this regard, the possible configuration actions listed in the configuration menu vary with respect to the object type and the view setting. A user may select a desired configuration action from the configuration menu, wherein the application server presents or otherwise provides a GUI on the client device corresponding to the selected configuration action. For clarity and ease of explanation, the subject matter is described herein in the context of configuration actions with respect to database objects, however, it will be appreciated in the art that the subject matter described herein is not limited to database objects and may be implemented in an equivalent manner for other configurable elements maintained in the database (e.g., configurable metadata or the like).

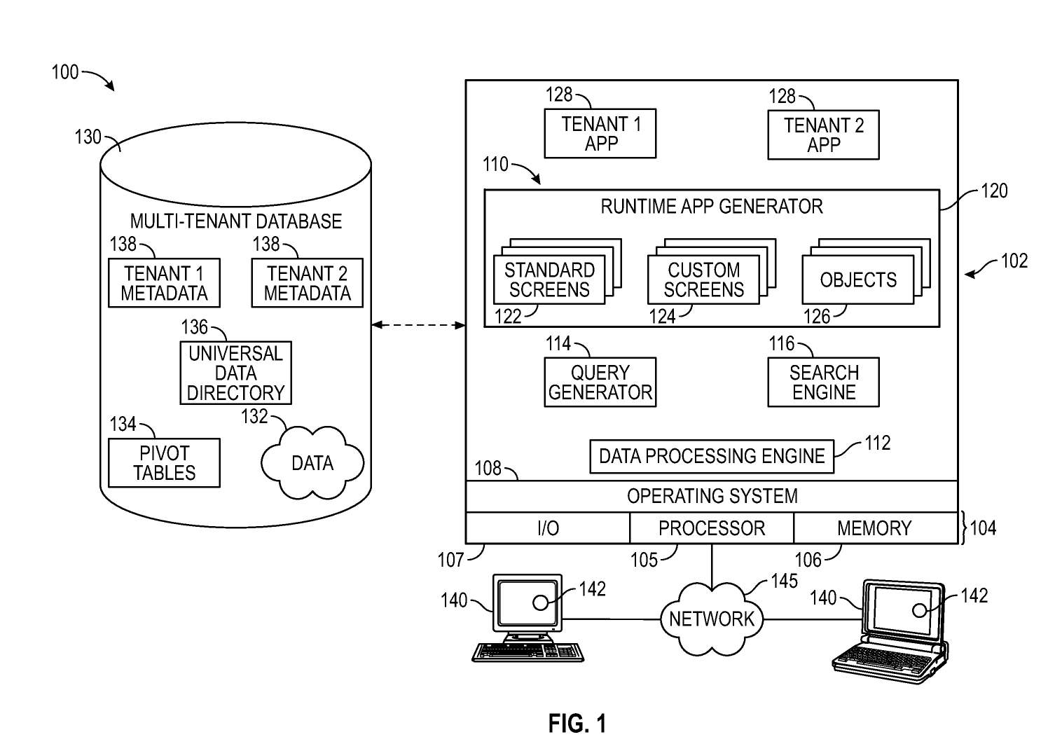

Turning now to FIG. 1, an exemplary multi-tenant system 100 includes an application server 102 that dynamically creates and supports virtual applications 128 based upon data 132 from a common database 130 that is shared between multiple tenants, alternatively referred to herein as a multi-tenant database. Data and services generated by the virtual applications 128 are provided via a network 145 to any number of client devices 140, as desired. Each virtual application 128 is suitably generated at run-time using a common application platform 110 that securely provides access to the data 132 in the database 130 for each of the various tenants subscribing to the multi-tenant system 100. In accordance with one non-limiting example, the multi-tenant system 100 is implemented in the form of a multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 130. In this regard, each tenant includes one or more users associated with, assigned to, or otherwise belonging to that respective tenant. To put it another way, each respective user within the multi-tenant system 100 is associated with, assigned to, or otherwise belongs to a particular tenant of the plurality of tenants supported by the multi-tenant system 100. Tenants may represent customers, customer departments, business or legal organizations, and/or any other entities that maintain data for particular sets of users within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other tenants.

The multi-tenant database 130 is any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein. In an exemplary embodiment, the database 130 includes a database management system or other equivalent software capable of determining an optimal query plan for retrieving and providing a particular subset of the data 132 to an instance of virtual application 128 in response to a query initiated or otherwise provided by the virtual application 128 (e.g., via query generator 114).

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 is implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like. The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media (not separately shown) that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

Still referring to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create data-driven virtual applications 128. Such virtual applications 128 may make use of interface features such as tenant-specific (or custom) screens 124, universal (or standard) screens 122 or the like. Any number of standard and/or custom objects 126 may also be available for integration into tenant-developed virtual applications 128. As used herein, “custom” should be understood as meaning that a respective object or application is user-specific (e.g., only available to a particular subset of users within the multi-tenant system) or tenant-specific (e.g., only available to users associated with a particular tenant in the multi-tenant system), whereas “standard” or “universal” applications or objects are available across multiple tenants in the multi-tenant system. The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular custom virtual application 128. In an exemplary embodiment, a virtual application 128 includes one or more custom objects 126 created or otherwise defined by a user and/or tenant. In this regard, for each custom object 126, information pertaining to its object type and its associated fields are maintained as metadata 138 in the database 130 while the values of the fields for each instance of that respective object 126 are maintained as data 132 in the multi-tenant database 130. In this regard, the metadata 138 for a custom object 126 defines the structure (e.g., the formatting, functions, fields and other constructs) of that respective custom object 126. As discussed above, although the subject matter is primarily described herein in the context of configuration actions with respect to custom and/or standard database objects 126 for clarity and ease of explanation, the subject matter described herein may be implemented in an equivalent manner for other configurable elements in the database 130, such as, for example, configurable instances of metadata 138 (e.g., configurable instances of metadata 138 defining configuration settings for custom screens 124 or other GUIs or features provided by the multi-tenant system 100).

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below. Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. As noted above, the virtual application 128 may contain Java, ActiveX, or other content that can be presented using conventional client software running on the client device 140; other embodiments may simply provide dynamic web or other content that can be presented and viewed by the user, as desired. The query generator 114 suitably obtains requested subsets of data 132 from the database 130 as needed to populate the tables, reports or other features of the particular virtual application 128.

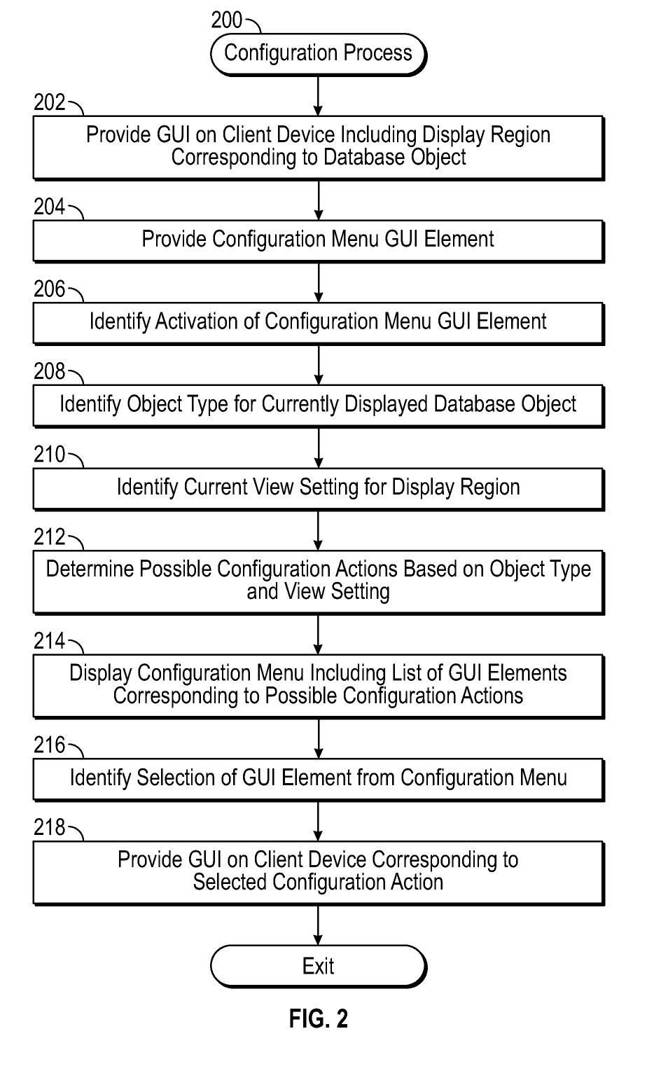

FIG. 2 depicts an exemplary configuration process 200 suitable for implementation by a multi-tenant system to allow a user to view, modify, edit, or otherwise configure objects within an instance of an application provided by an application server to the user's client device. The various tasks performed in connection with the configuration process 200 may be performed by software, hardware, firmware, or any combination thereof. For illustrative purposes, the following description may refer to elements mentioned above in connection with FIG. 1. In practice, portions of the configuration process 200 may be performed by different elements of the multi-tenant system 100, such as, for example, the application server 102, the application platform 110, the multi-tenant database 130, the virtual application 128, the client device 140 and/or the client application 142. It should be appreciated that the configuration process 200 may include any number of additional or alternative tasks, the tasks need not be performed in the illustrated order and/or the tasks may be performed concurrently, and/or the configuration process 200 may be incorporated into a more comprehensive procedure or process having additional functionality not described in detail herein. Moreover, one or more of the tasks shown and described in the context of FIG. 2 could be omitted from a practical embodiment of the configuration process 200 as long as the intended overall functionality remains intact.

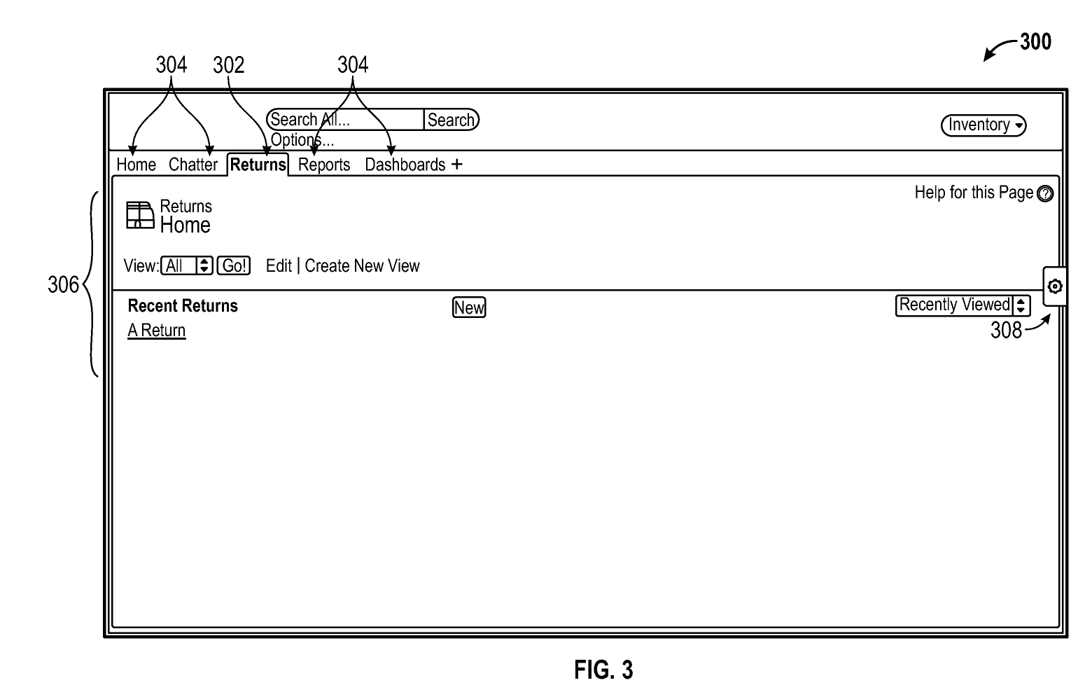

Referring to FIG. 2, and with continued reference to FIG. 1, in an exemplary embodiment, the configuration process 200 begins by presenting or otherwise providing a graphical user interface on a client device that includes a display region corresponding to a database object or another configurable database element (task 202). In an exemplary embodiment, the user of the client device 140 manipulates or otherwise operates the client application 142 to access the application platform 110 and/or the application server 102, wherein the application platform 110 generates an instance of a virtual application 128 that is available to the user of the client device 140 and presents or otherwise displays, within the client application 142, a graphical user interface corresponding to the instance of a virtual application 128. The virtual application 128 may be a standard application available to multiple tenants within the multi-tenant system 100 or a custom application that is only available to the particular user of the client device 140 and/or the user's tenant. In an exemplary embodiment, the GUI for the virtual application 128 provided to the client device 140 is a tabbed interface that includes one or more tabs corresponding to one or more types of standard and/or custom objects 126 in the multi-tenant database 130. The tabbed interface may also include one or more tabs corresponding to standard functions, tables, reports, interfaces and/or features supported by the multi-tenant system 100. As used herein, a tab should be understood as a graphical affordance associated with a particular type of object 126 or a particular feature and/or functionality within the multi-tenant system 100. When a custom object tab or standard object tab is activated or otherwise selected, the application platform 110 and/or virtual application 128 presents or otherwise provides, within a display region of the tabbed interface, a display corresponding to that respective type of object 126. In this regard, the database object display provided in the display region may include GUI elements, data columns and/or fields, and/or other information corresponding to that particular object type, as described in greater detail below in the context of FIG. 3.

In an exemplary embodiment, the configuration process 200 continues by presenting, displaying, or otherwise providing a GUI element for a configuration menu within the virtual application (task 204). In this regard, the application platform 110 and/or virtual application 128 displays or otherwise presents a button, icon, or another selectable GUI element for a configuration menu overlying the tabbed interface. In response to identifying a user selecting or otherwise activating the configuration menu GUI element (task 206), the configuration process 200 continues by presenting, displaying, or otherwise providing a configuration menu overlying the tabbed interface that includes a list of GUI elements corresponding to different possible configuration actions for the object type of currently displayed database object (e.g., the database object corresponding to the display region). In an exemplary embodiment, the configuration process 200 identifies the object type for the currently displayed database object and the current view setting for the display region, determines the possible configuration actions for the configuration menu based on the current object type and the current view setting, and displays a configuration menu that includes GUI elements corresponding to those possible configuration actions (tasks 208, 210, 212, 214). In this regard, the different configuration actions presented within the configuration menu are context-sensitive and vary with respect to the type of object being viewed or otherwise displayed within the virtual application, and also, may vary with respect to the view setting for the database object display. In response to identifying selection of a GUI element within the configuration menu (task 216), the configuration process 200 continues by presenting or otherwise providing a GUI corresponding to the selected configuration action (task 218). In this regard, the application platform 110 and/or virtual application 128 may present or otherwise provide a GUI within the client application 142 for performing the configuration action on the type of database object displayed within the virtual application 128 or a displayed instance of that type of database object, as described in greater detail below.

FIGS. 3-5 illustrate an exemplary sequence of GUIs that may be graphically presented by the application platform 110 within a client application 142 executing on a client device 140 in connection with an exemplary embodiment of the configuration process 200 of FIG. 2. In this regard, the displays illustrated in FIGS. 3-5 represent a portion of the visual area on the electronic display device associated with client device 140 that contains graphical representations or images associated with the client application 142 which generates, conveys, renders, or otherwise displays graphical representations or images based on data received from the application platform 110 and/or a virtual application 128. In practice, the displays may be realized as or otherwise derived from one or more screens (e.g., screens 122, 124) integrated with or otherwise supported by the application platform 110 and/or virtual application 128.

Referring to FIG. 3, in an exemplary embodiment, the application platform 110 generates or otherwise executes a virtual application 128, and provides the virtual application 128 to the client device 140 by presenting or otherwise displaying a tabbed interface display 300 within the client application 142 that corresponds to the set of tabs associated with the virtual application 128. In the illustrated embodiment, the virtual application 128 is a custom application, and the tabbed interface display 300 includes a custom object tab 302 corresponding to a custom object type in the multi-tenant database 130 (e.g., a “Return” object type) along with standard tabs 304 associated with standard features and/or functionality provided by the multi-tenant system 100 across multiple tenants. As illustrated, in an exemplary embodiment, the tabbed interface display 300 is initially configured so that the custom object tab 302 is activated or otherwise selected by default, such that a display region 306 of the tabbed interface display 300 includes GUI elements and/or other information corresponding to the custom object type. For example, the custom object display in the display region 306 may include a listing of instances of the custom object type in the multi-tenant database 130 with columns corresponding to one or more fields or other attributes of the custom object type, along with buttons or other GUI elements adapted to allow the user to create new instances of the custom object type in the multi-tenant database 130, sort instances of the custom object type based on their respective values for the various fields of the custom object, generate reports, or perform other functions supported by the virtual application 128 and/or the multi-tenant system 100.

As illustrated in FIG. 3, while the custom object tab 302 is activated so that the corresponding custom object display is presented in the display region 306, the application platform 110 provides a configuration menu GUI element 308 within the tabbed interface display 300. In an exemplary embodiment, the configuration menu GUI element 308 is displayed along a periphery of the tabbed interface display 300 and at a fixed location within the display area occupied by the client application 142. That is, the configuration menu GUI element 308 may remain at a fixed location on the client device 140 even though the underlying content of the tabbed interface display 300 may be scrolled or otherwise have a variable location with respect to the display area on the client device 140.

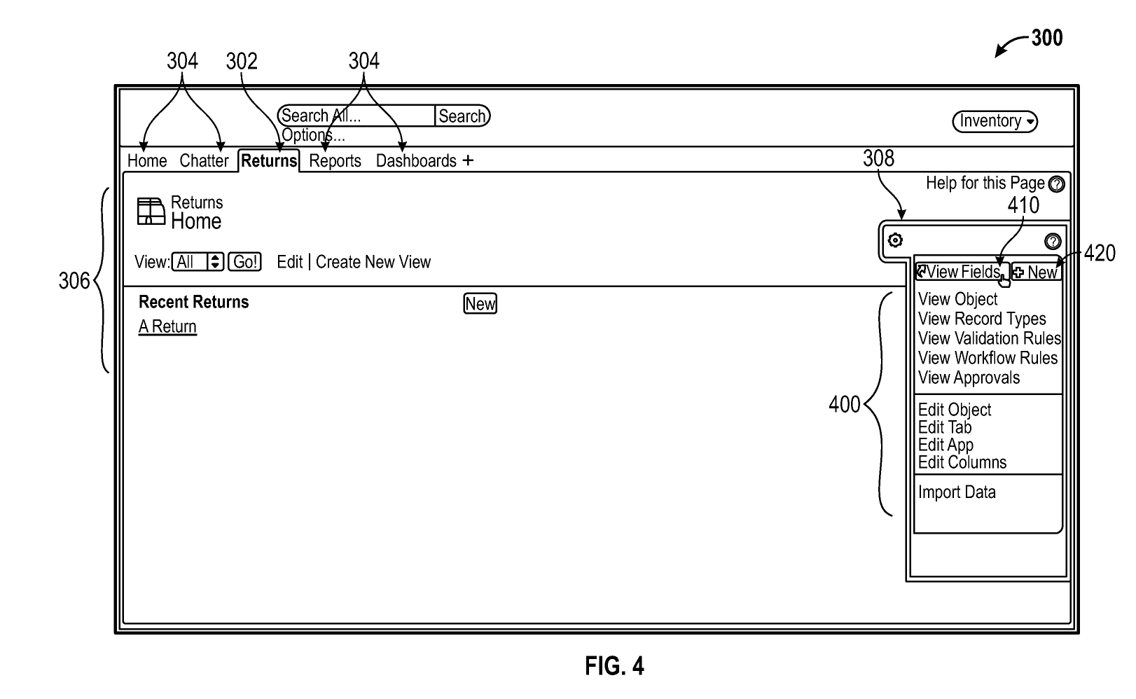

Turning now to FIG. 4, when a user of the client device 140 selects or otherwise activates the configuration menu GUI element 308 (e.g., by selecting the configuration menu GUI element 308 or moving a cursor over the configuration menu GUI element 308), the application platform 110 displays or otherwise presents a configuration menu 400 associated with the configuration menu GUI element 308 that includes a list of the possible configuration actions for the currently displayed database object type (e.g., the database object type corresponding to the selected tab and represented in the display region 306). The menu 400 includes selectable GUI elements (e.g., hyperlinks, buttons, or the like) corresponding to the different possible configuration actions identified by the application platform 110, such as, for example, viewing the data fields of the current database object type (e.g., “View Fields”), viewing the metadata of the current database object type (e.g., “View Object”), viewing the record types of the current database object type (e.g., “View Record Types”), viewing the validation rules associated with the current database object type (e.g., “View Validation Rules”), and the like. In the illustrated embodiment, the menu 400 also includes selectable GUI elements for editing or otherwise modifying the current application (e.g., “Edit App”), editing or otherwise modifying the columns displayed within the display region 306 for the currently displayed database object type (e.g., “Edit Columns”), and importing or otherwise adding data for creating new instances of the current database object type in the multi-tenant database 130 (e.g., “Import Data”).

As described above in the context of FIG. 2, in an exemplary embodiment, the application platform 110 identifies the possible configuration actions based on whether the currently displayed database object type is a custom or standard object in the multi-tenant system 100. In this regard, based on the “Return” object type associated with the selected custom object tab 302 being a custom object, the application platform 110 identifies, as possible configuration actions, editing or otherwise modifying the metadata (or structure) of the custom object type (e.g., “Edit Object”) and editing or otherwise modifying the tab corresponding to the custom object type (e.g., “Edit Tab”). Additionally, the application platform 110 identifies, as possible configuration actions, adding additional structure and/or attributes to the custom object, such as, for example, adding new data fields, new record types, new validation rules, and the like. As illustrated in FIG. 4, in an exemplary embodiment, the selectable GUI elements for adding additional structure and/or attributes to the custom object are displayed within the configuration menu 400 in-line with the GUI elements for viewing those structures and/or attributes. For example, a hyperlink 420 for adding a new data field to the “Return” object type is displayed within the configuration menu 400 in-line with a hyperlink 410 for viewing the data fields of the “Return” object type.

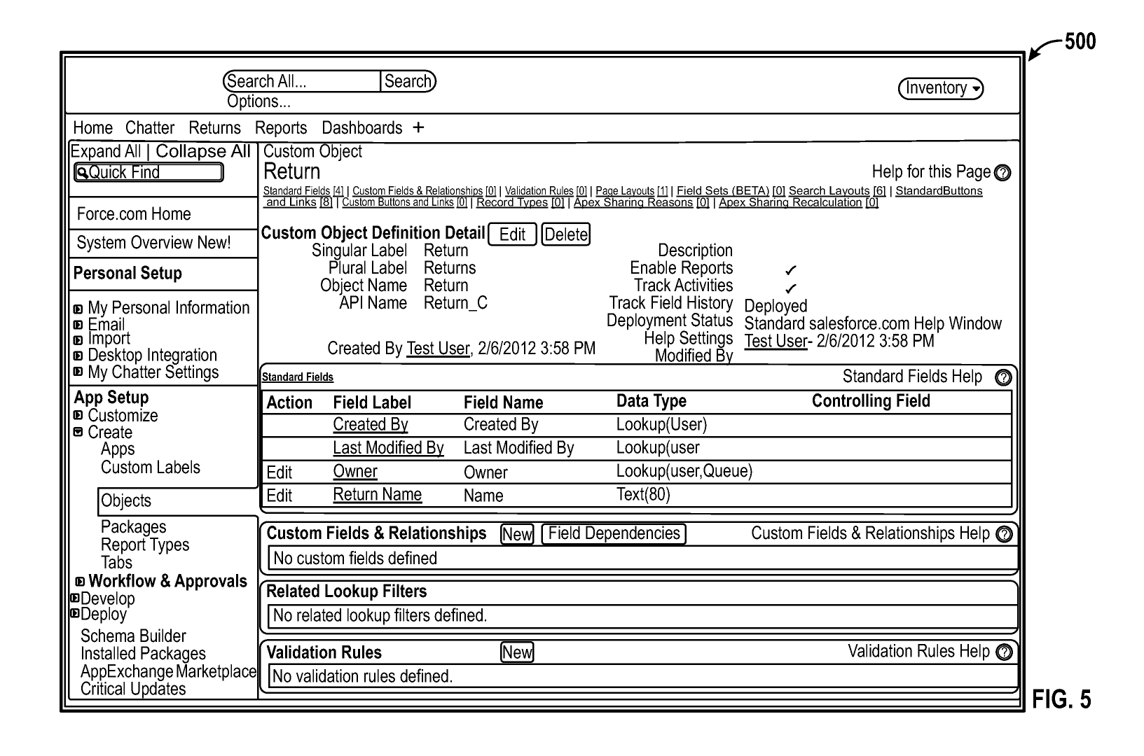

Turning now to FIG. 5, the user may manipulate a user input device associated with the client device 140 (e.g., a mouse, keyboard, touch panel, or the like) to select or otherwise indicate, from the configuration menu 400, the desired configuration action to be performed with respect to the currently displayed database object type. For example, as illustrated, the user may select the “View Fields” hyperlink 410 from the menu 400 to view the data fields of the “Return” custom object type. In response to identifying selection of the “View Fields” configuration action, the application platform 110 obtains the metadata 138 defining the structure and/or data fields of the “Return” custom object type from the multi-tenant database 130 and presents or otherwise provides a GUI display 500 that includes a listing of the data fields associated with the “Return” custom object type, thereby displaying the data fields of the “Return” custom object type to the user of the client device 140. In the illustrated embodiment, the view fields GUI display 500 is realized as a tabbed interface display that includes tabs corresponding to the set of tabs associated with the instance of the custom application 128 (e.g., the same custom object tab 302 and standard tabs 304 as the custom application tabbed interface display 300). In some embodiments, the GUI display 500 is presented or otherwise displayed overlying the tabbed interface display 300 for the virtual application 128, either within the client browser application 142 (e.g., as a new tab within a web browser) or a new instance of the client application 142 (e.g., as a new web browser window). In other embodiments, the display region 306 of the tabbed interface display 300 may be updated to include a listing of the data fields associated with the “Return” custom object type.

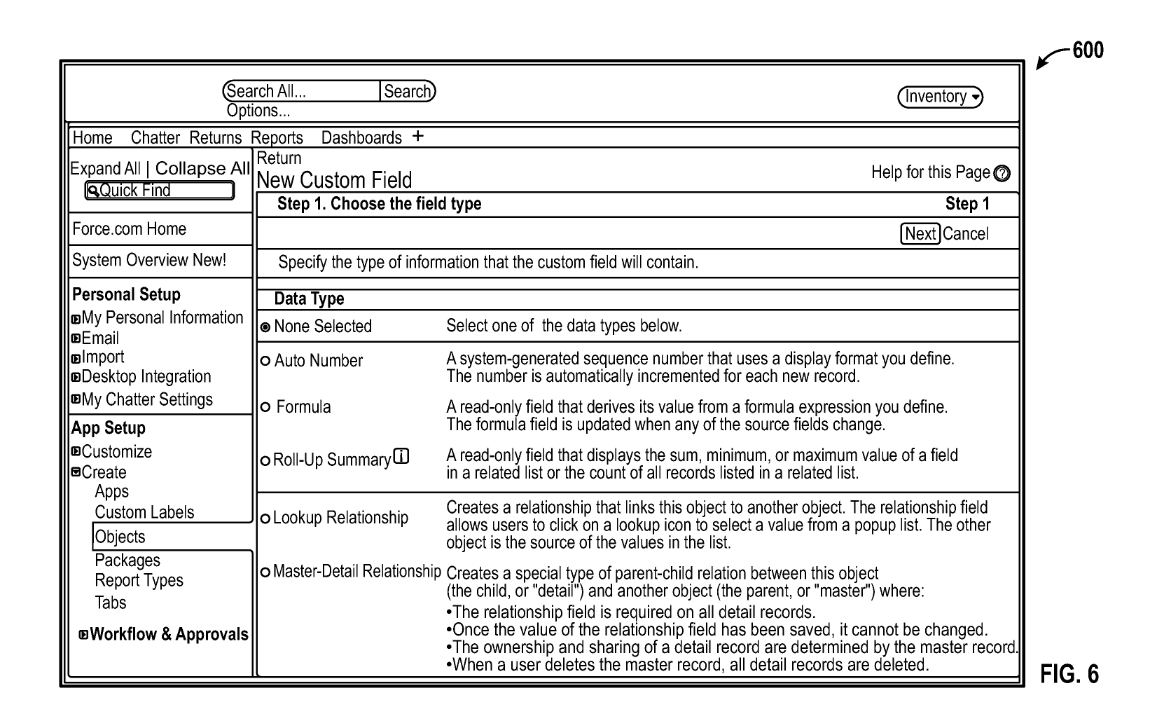

FIG. 6 depicts an exemplary GUI display 600 that may be presented on the client device 140 in response to the user manipulating a user input device to select or otherwise indicate adding a new data field to the “Return” custom object (e.g., hyperlink 420) as the desired configuration action from the configuration menu 400. In this regard, the GUI display 600 includes GUI elements adapted to allow the user to create or otherwise define the additional data field(s) that the user would like to add to the structure of the “Return” custom object type. In response to identifying selection of the add new field configuration action hyperlink 420, the application platform 110 presents or otherwise provides the new field GUI display 600 that includes GUI elements adapted to allow the user to create or otherwise define the data type, lookup relationships, and other attributes of the additional data field that the user would like to add to the structure of the “Return” custom object type. After the user manipulates the GUI elements of the GUI display 600 to define the attributes of the new field to be added to the “Return” custom object type, the application platform 110 modifies the metadata 138 for the “Return” custom object type to provide the new field associated with instances of the “Return” custom object type. In the illustrated embodiment, the new field GUI display 600 is realized as a tabbed interface display that includes tabs corresponding to the set of tabs associated with the instance of the custom application 128 (e.g., the same custom object tab 302 and standard tabs 304 as the custom application tabbed interface display 300). In some embodiments, the GUI display 600 is presented or otherwise displayed overlying the tabbed interface display 300 for the virtual application 128, either within the client browser application 142 (e.g., as a new tab within a web browser) or a new instance of the client application 142 (e.g., as a new web browser window), while in other embodiments, the display region 306 of the tabbed interface display 300 may be updated to include GUI elements for creating a new field to be associated with the “Return” custom object type.

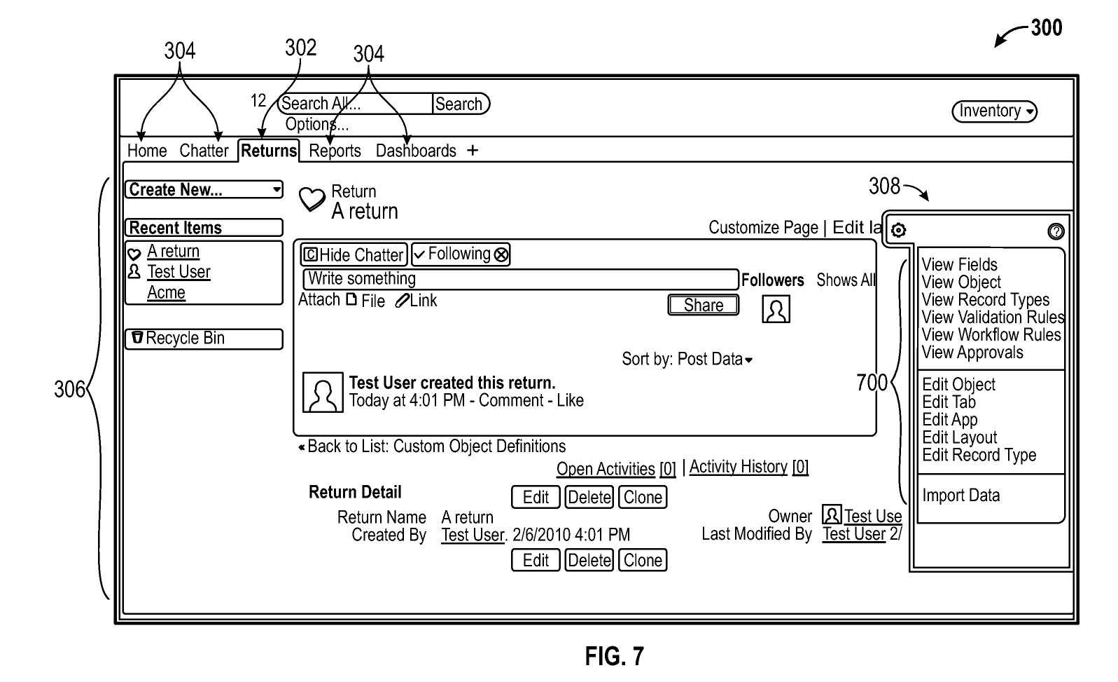

Turning now to FIG. 7 with reference to FIGS. 1-4, as described above in the context of FIG. 2, in an exemplary embodiment, the application platform 110 also identifies the possible configuration actions for the configuration menu based on the view setting for the display region. When the user selects a detail view for the custom object display in the display region 306, the application platform 110 identifies different possible configuration actions for the configuration menu 700 relative to the configuration menu 400 presented when a list view is selected for the custom object display, as illustrated in FIGS. 3-4. In this regard, the possible configuration actions provided in the configuration menu vary with respect to the view setting. As illustrated in FIG. 7, based on the current view setting for the display region 306 being the detail view setting (e.g., to view metadata for an instance of a “Return” custom database object in the display region 306), the application platform 110 identifies editing or otherwise modifying the layout of the detail view as a possible configuration action and displays a corresponding GUI element in the configuration menu 700 (e.g., “Edit Layout”). Additionally, based on the display region 306 corresponding to a custom object type and the detail view setting, the application platform 110 also identifies editing or otherwise modifying the metadata for the record type associated with the instance of the custom object presented in the display region 306 as a possible configuration action and displays a corresponding GUI element in the configuration menu 700 (e.g., “Edit Record Type”).

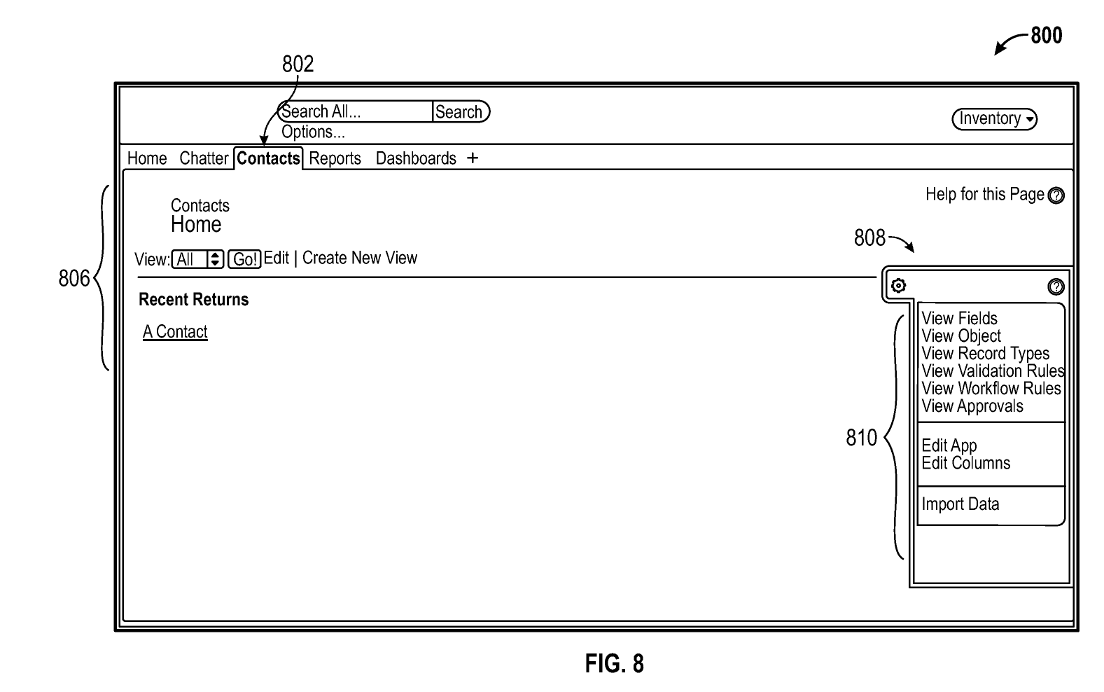

Turning now to FIG. 8 with reference to FIGS. 1-4, as described above, in an exemplary embodiment, the application platform 110 identifies the possible configuration actions based on whether the currently displayed database object type is a custom or standard object in the multi-tenant system 100. In this regard, FIG. 8 depicts a tabbed interface display 800 within the client application 142 that includes a standard object tab 802 corresponding to a standard object type in the multi-tenant database 130 (e.g., a “Contact” object type). When the standard object tab 802 is activated or otherwise selected and the user selects or otherwise activates the configuration menu GUI element 808, the application platform 110 displays or otherwise presents a configuration menu 810 associated with the configuration menu GUI element 808 that includes a list of the possible configuration actions for the “Contact” object type. Based on the “Contact” object type being a standard database object in the multi-tenant system 100, the application platform 110 does not identify, as possible configuration actions, editing or otherwise modifying the structure of the standard object (e.g., “Edit Object”), editing or otherwise modifying the tab corresponding to the standard object (e.g., “Edit Tab”), or adding additional structure and/or attributes to the standard object. In this regard, the possible configuration actions provided in the configuration menu vary with respect to the type of database object presented in the display region of the tabbed interface display, and the number of possible configuration actions in the configuration menu may be less for standard objects than for custom objects, as illustrated by FIGS. 4 and 8. Additionally, based on the list view setting for the display region 806, the application platform 110 does not identify editing or otherwise modifying the layout of the detail view of the object (e.g., “Edit Layout”) as a possible configuration action.

To briefly summarize, on advantage of the configuration process 200 is that the application platform 110 provides, within a virtual application 128 presented on a client device 140, a configuration menu that includes configuration actions that are likely to be relevant or otherwise desired by the user of the client device 140 based on the type of database object currently being displayed within the virtual application 128 and the current view setting for the database object display, as illustrated by FIGS. 3-4 and 7-8. The user may utilize the configuration menu to perform a desired configuration action at run-time (e.g., while the instance of the virtual application 128 is being generated or otherwise executed by the application server 102). In response to identifying selection of a possible configuration action, the application platform 110 presents or otherwise provides a GUI corresponding to the selected configuration action, for example, by displaying various data fields and/or attributes of the current database object or providing a GUI including GUI elements for adding and/or editing various data fields and/or attributes of the current database object, as illustrated in FIGS. 5-6. Thus, the user may view, modify, or otherwise configure aspects of the virtual application and the database objects integrated therewith in a simplified manner at run-time without having to navigate through multiple different setup windows to perform a desired configuration action.

It will be appreciated that the foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, application virtualization, multi-tenancy, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another. That said, in exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for configuring a configurable element in a multi-tenant database, the method comprising:
providing a graphical user interface including a display region corresponding to the configurable element;
identifying an object type for the configurable element;
determining a possible configuration action for the configurable element based at least in part on the object type; and
providing a graphical user interface element corresponding to the possible configuration action within the graphical user interface.

2. The method of claim 1, further comprising providing a second graphical user interface corresponding to the possible configuration action in response to selection of the graphical user interface element.

3. The method of claim 2, the configurable element comprising a database object, wherein providing the second graphical user interface comprises providing one or more graphical user interface elements for performing the possible configuration action with respect to the database object.

4. The method of claim 2, the configurable element comprising a database object, wherein providing the second graphical user interface comprises:
obtaining metadata for the database object from a database; and
displaying the metadata within the second graphical user interface.

5. The method of claim 1, further comprising identifying a view setting for the display region, wherein determining the possible configuration action comprises determining the possible configuration action based on the object type and the view setting.

6. The method of claim 1, further comprising
determining a plurality of possible configuration actions for the configurable element based at least in part on the object type; and
providing a configuration menu within the graphical user interface, the configuration menu including a plurality of graphical user interface elements corresponding to the plurality of possible configuration actions, wherein the configuration menu includes the graphical user interface element.

7. The method of claim 6, further comprising identifying a view setting for the display region, wherein the plurality of possible configuration actions are determined based on the view setting and the object type.

8. The method of claim 7, wherein the plurality of possible configuration actions varies with respect to the object type or the view setting.

9. The method of claim 6, further comprising providing a configuration menu graphical user interface element within the graphical user interface, wherein providing the configuration menu comprises displaying the configuration menu in response to activation of the configuration menu graphical user interface element.

10. The method of claim 1, the configurable element comprising a database object, wherein determining the possible configuration action for the database object comprises determining editing a structure of the database object as the possible configuration action when the object type corresponds to a custom object.

11. The method of claim 1, further comprising generating, by an application server, an instance of a virtual customer relationship management (CRM) application, wherein providing the graphical user interface comprises displaying a tabbed interface display corresponding to the virtual CRM application on a client device coupled to the application server, the tabbed interface display including a tab corresponding to the configurable element.

12. A method for configuring objects in a multi-tenant system, the multi-tenant system including a multi-tenant database and an application server providing virtual applications to a plurality of tenants over a network, the method comprising:
providing, by the application server, a graphical user interface corresponding to an instance of a virtual application on a client device coupled to the application server, the graphical user interface including a display region corresponding to a first object in the multi-tenant database;
identifying an object type for the first object;
determining one or more possible configuration actions for the first object based at least in part on the object type; and
providing a configuration menu within the instance of the virtual application, the configuration menu including one or more graphical user interface elements corresponding to the one or more possible configuration actions.

13. The method of claim 12, further comprising identifying a view setting for the display region, wherein the one or more possible configuration actions are determined based on the view setting for the display region.

14. The method of claim 12, wherein determining the one or more possible configuration actions comprises determining editing a structure of the first object as a possible configuration action when the object type indicates the first object is specific to a first tenant of the plurality of tenants.

15. The method of claim 12, further comprising:
identifying selection of a first graphical user interface element from the configuration menu, the first graphical user interface element corresponding to a first possible configuration action; and
providing, by the application server, a second display on the client device corresponding to the first possible configuration action with respect to the first object in response to identifying selection of the first graphical user interface element.

16. The method of claim 15, the first possible configuration action corresponding to modifying metadata corresponding to the first object, the metadata being maintained by the multi-tenant database, wherein the second display includes a graphical user interface element for modifying the metadata maintained by the multi-tenant database.

17. A computer system comprising a processor and a memory, wherein the memory comprises computer-executable instructions that, when executed by the processor, cause the computer system to:
provide a graphical user interface including a display region corresponding to a first object obtained from a database;
identify an object type for the first object;
determine a possible configuration action for the first object based at least in part on the object type; and
provide a graphical user interface element corresponding to the possible configuration action within the graphical user interface.

18. The computer system of claim 17, wherein the computer-executable instructions cause the computer system to identify a view setting for the display region, wherein the possible configuration action is determined based on the view setting.

19. The computer system of claim 18, wherein the computer-executable instructions cause the computer system to:
determine a plurality of possible configuration actions for the first object based on the object type and the view setting; and
provide a configuration menu including a plurality of graphical user interface elements corresponding to the plurality of possible configuration actions within the graphical user interface.

20. The computer system of claim 17, wherein the graphical user interface comprises a tabbed interface display corresponding to an instance of a virtual application provided to a client device, the tabbed interface display including a tab corresponding to the first object, wherein display region corresponds to the first object when the tab is activated.
